(19) United States
(12) Patent Application Publication
(10) Pub. No.: US 2012/0299866 A1
(43) Pub. Date: Nov. 29, 2012

(54) INPUT APPARATUS HAVING CAPACITIVE TOUCH ELEMENT AND PRESSURE-BASED SENSING ELEMENT INTEGRATED THEREIN, AND TOUCH EVENT PROCESSING METHOD THEREOF

(76) Inventors: Tien-Wen Pao, Hsinchu County (TW); Chien-Hui Wu, Tainan City (TW); Bor-Lin Jung, Yilan County (TW)

(21) Appl. No.: 13/214,255

(22) Filed: Aug. 22, 2011

(30) Foreign Application Priority Data
May 27, 2011 (TW) 100118619

(51) Int. Cl. G06F 3/044

(52) U.S. Cl. 345/174

(57) ABSTRACT

An input apparatus includes a capacitive touch element, at least a pressure-based sensing element, and a control circuit. The control circuit includes a switch unit and a shared processing unit. The switch unit is coupled to the capacitive touch element and the pressure-based sensing element, for selectively generating an output signal according to a touch signal generated by the capacitive touch element or a sensor signal generated by the pressure-based sensing element. The shared processing unit is coupled to the switch unit, for processing the output signal to detect a touch event. A touch event processing method includes scanning traces for detecting if a touch event occurs, checking whether the touch event occurs in a capacitive touch element or a pressure-based sensing element, and processing the touch event with a corresponding algorithm.

### BACKGROUND OF THE INVENTION

1. Field of the Invention

The present invention relates to an input apparatus, and more particularly, to the input apparatus having a capacitive touch element and a pressure-based sensing element integrated in a single chip, and a related touch event processing method.

2. Description of the Prior Art

Integration of two-dimensional (2D) capacitive multi-finger touch technology and three-dimensional (3D) pressure sensor provides the user with a variety of control modes and various application aspects, such as mouse/cursor control mode, joystick/jog wheel control mode, handwriting mode, etc. However, because it is required to utilize a multi-chip integrated circuit in the fabrication process, the manufacture cost is thus increased.

### SUMMARY OF THE INVENTION

It is therefore an objective of the claimed invention to provide an input apparatus having a capacitive touch element and a pressure-based sensing element integrated in a single chip, which not only provides various application aspects, but also reduces the manufacture cost.

According to an embodiment of the present invention, an exemplary input apparatus is disclosed. The exemplary input apparatus includes a capacitive touch element, at least a pressure-based sensing element, and a control circuit. The control circuit includes a switch unit and a shared processing unit. The switch unit is coupled to the capacitive touch element and the pressure-based sensing element, for selectively generating an output signal according to a touch signal generated by the capacitive touch element or a sensor signal generated by the pressure-based sensing element. The shared processing unit is coupled to the switch unit, for processing the output signal to detect a touch event.

According to an embodiment of the present invention, another exemplary input apparatus is disclosed. The exemplary input apparatus includes a capacitive touch element, a capacitive pressure sensor, a trace switch, and a shared processing unit. The trace switch is coupled to the capacitive touch element and the capacitive pressure sensor, for performing switching between the capacitive touch element and the capacitive pressure sensor to generate an output signal. The shared processing unit is coupled to the trace switch, for selectively executing first firmware corresponding to the capacitive touch element or second firmware corresponding to the capacitive pressure sensor to process the output signal according to the switching of the trace switch to detect a touch event.

According to an embodiment of the present invention, another exemplary input apparatus is disclosed. The exemplary input apparatus includes a capacitive touch element, a resistive pointing stick, a first trace switch, a converter, a second trace switch, and a shared processing unit. The first trace switch is for selectively outputting an output of the resistive pointing stick, the converter is for converting the output of the resistive pointing stick, the second trace switch is for selectively outputting an output of the capacitive touch element, and shared processing unit is coupled to the converter and the second trace switch, for selectively executing first firmware to process the output of the capacitive touch element or second firmware to process an output of the converter according to the switching of the first trace switch and the second trace switch to detect a touch event.

According to an embodiment of the present invention, a touch event processing method is disclosed. The exemplary touch event processing method includes scanning traces for detecting if a touch event occurs, checking if the touch event occurs in a capacitive touch element or a pressure-based sensing element, performing algorithm corresponding to the capacitive touch element on the touch event when the touch event occurs in the capacitive touch element, and performing algorithm corresponding to the pressure-based sensing element on the touch event when the touch event occurs in the pressure-based sensing element.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a generalized input apparatus according to an embodiment of the present invention.

FIG. 2 is a diagram illustrating a first exemplary implementation of the exemplary input apparatus shown in FIG. 1.

FIG. 3 is a diagram illustrating the switching and connection of traces shown in FIG. 2.

FIG. 4 is a diagram illustrating a second exemplary implementation of the exemplary input apparatus shown in FIG. 1.

FIG. 5 is a diagram illustrating the switching and connection of traces shown in FIG. 4.

FIG. 6 is a diagram illustrating a third exemplary implementation of the exemplary input apparatus shown in FIG. 1.

FIG. 7 is a flowchart of the circuit switching and firmware control of the exemplary input apparatus according to an embodiment of the present invention.

### DETAILED DESCRIPTION

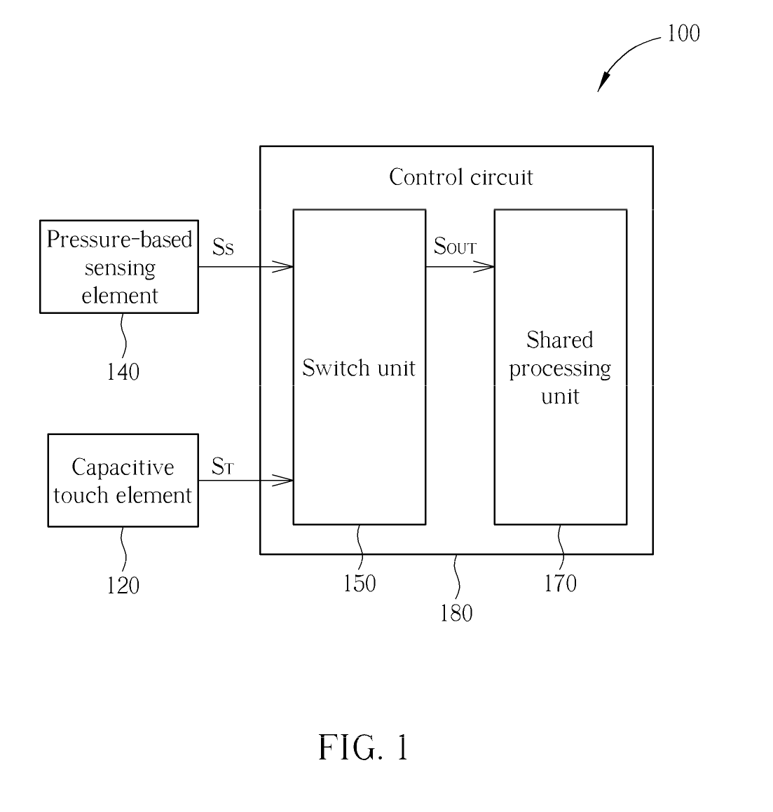

Please refer to FIG. 1, which is a block diagram illustrating a generalized input apparatus according to an embodiment of the present invention. The input apparatus 100 includes, but is not limited to, a capacitive touch element 120, a pressure-based sensing element 140, and a control circuit 180. The control circuit 180 includes a switch unit 150 and a shared processing unit 170. In a preferred implementation, the capacitive touch element 120, the pressure-based sensing element 140, and the control circuit 180 are all integrated in the same chip. However, this is for illustrative purposes only, and is not meant to be a limitation to the scope of the present invention. In other words, any input apparatus employing the structure with the shared processing unit of the present invention obeys the spirit of the present invention and falls within the scope of the present invention.

As shown in FIG. 1, the switch unit 150 is coupled to the capacitive touch element 120 and the pressure-based sensing element 140, and used for selectively generating an output signal S_{OUT} according to a touch signal S_{T} generated by the capacitive touch element 120 or a sensor signal S_{S} generated by the pressure-based sensing element 140. The shared processing unit 170 is coupled to the switch unit 150, and used for processing the output signal S_{OUT} to detect a touch event. In addition, the shared processing unit 170 further controls switching of the switch unit 150 according to a touch sequence of the capacitive touch element 120 and the pressure-based sensing element 140 (this feature is not shown in FIG. 1). For example, when there is a touch event occurring in the capacitive touch element 120 and no action in the pressure-based sensing element 140, the shared processing unit 170 controls the switch unit 150 to receive the touch signal S_{T} first to generate the output signal S_{OUT}, and then the output signal S_{OUT} is processed by the shared processing unit 170 to be converted into touch coordinates or other related touch data. In addition, the control circuit 180 continues processing the touch event until the touch event is no longer valid. For example, touching the capacitive touch element 120 by fingers triggers a touch event, and the control circuit 180 may continue processing the touch event until the fingers leave the capacitive touch element 120. Similarly, when there is a touch event occurring in the pressure-based sensing element 140 and no action in the capacitive touch element 120, the shared processing unit 170 controls the switch unit 150 to receive the sensor signal S_{S} first to generate the output signal S_{OUT}, and then the output signal S_{OUT} is processed by the shared processing unit 170 to be converted into touch coordinates or other related touch data. As can be known from above, the exemplary input apparatus 100 may employ the switch unit 150 and the shared processing unit 170 to accomplish the objective of having the capacitive touch element 120 and the pressure-based sensing element 140 integrated in the same chip. Operational details are described hereinafter with reference to a plurality of embodiments.

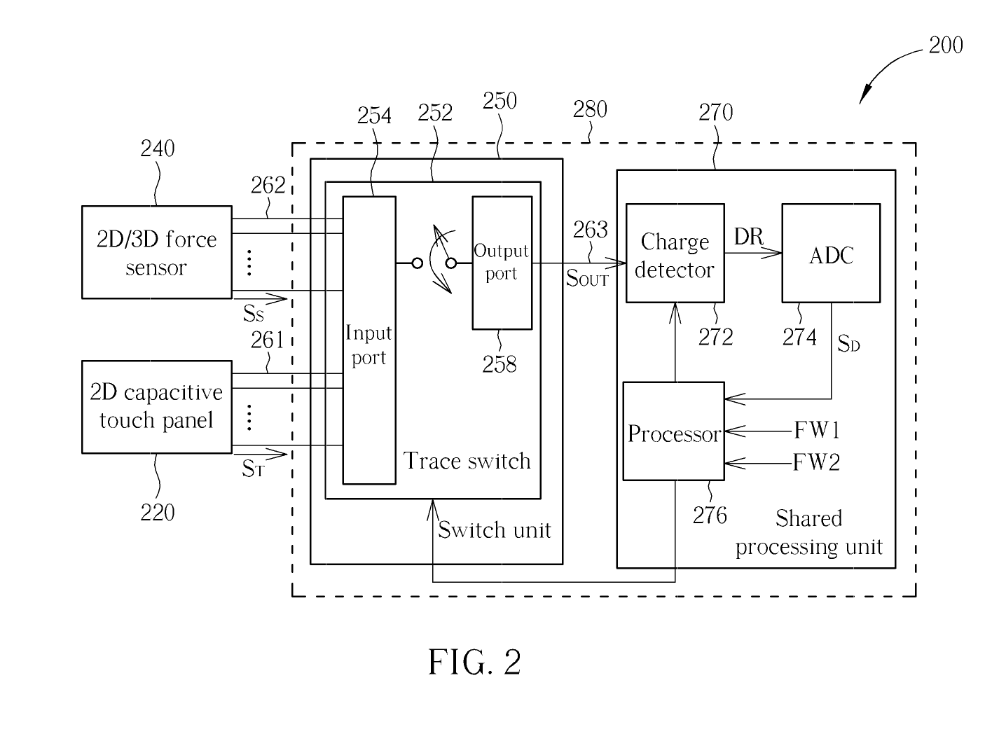

Please refer to FIG. 2, which is a diagram illustrating a first exemplary implementation of the input apparatus shown in FIG. 1. The exemplary input apparatus 200 is based on the structure shown in FIG. 1, and therefore includes, but is not limited to, a 2D capacitive touch panel 220, a 2D/3D force sensor 240, and a control circuit 280, where the control circuit 280 includes a switch unit 250 and a shared processing unit 270. In this embodiment, the switch unit 250 includes a trace switch 252, and the shared processing unit 270 includes a charge detector 272, an analog-to-digital converter (ADC) 274, and a processor 276. The trace switch 252 has an input port 254 and an output port 258, and is used for selectively coupling the output port 258 to the input port 254, wherein the output port 258 is used to provide the output signal S_{OUT} to a back-end processing circuit (e.g., the charge detector 272). The 2D capacitive touch panel 220 is connected to the input port 254 via traces 261, the 2D/3D force sensor 240 is connected to the input port 254 via traces 262, and the switch unit 250 is connected to the shared processing unit 270 via a trace 263.

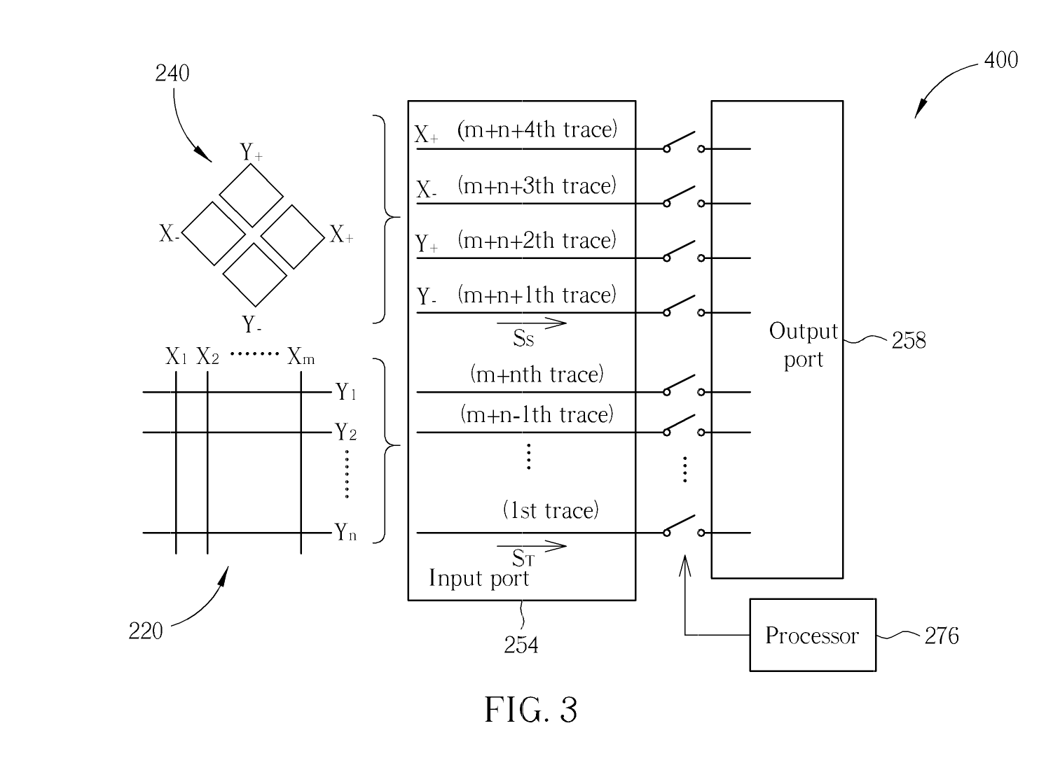

The charge detector 272 is coupled to the output port 258 of the trace switch 252, and used for performing charge detection on the output signal S_{OUT} outputted by the output port 258 to generate a detection result DR. The ADC 274 is coupled between the charge detector 272 and the processor 276, and used to convert the detection result DR into a digital signal S_{D} and output the digital signal S_{D} to the processor 276, where the processor 276 detects a touch event according to the digital signal S_{D}. For example, the processor 276 may detect a touch event by executing firmware, such as first firmware FW1 or second firmware FW2. In addition, the processor 276 controls the switching of the trace switch 252 according to a touch sequence of the 2D capacitive touch panel 220 and the 2D/3D force sensor 240, and the charge detection performed by the charge detector 272 is also controlled by the processor 276. With regard to the operational details of the trace switch 252 and the trace connection, please refer to FIG. 3 in conjunction with FIG. 2.

FIG. 3 is a diagram illustrating the switching and connection of the traces shown in FIG. 2. For illustrative purposes, the sensing mode of the 2D/3D force sensor 240 in this embodiment is set to be a self-capacitance mode, and the sensing mode of the 2D capacitive touch panel 220 in this embodiment is set to be a mutual capacitance mode. As shown in FIG. 3, four coplanar traces X₊, X₋, Y₊, and Y₋, connecting a plurality of rhombic electrodes, are needed in the 2D/3D force sensor 240, where there is no trace needed in the direction vertical to the plane (not shown) on which the traces X₊, X₋, Y₊, and Y₋ are disposed because the sensing operation is performed with capacitance variations generated from the pressure-induced physical deformation of the rubber; and m+n traces, including trace X₁-Xₘ and trace Y₁-Yₙ, are needed in the 2D capacitive touch panel 220. Therefore, there are m+n+4 traces connected to the input port 254 of the trace switch 252.

When a touch event occurs, the processor 276 detects the touch sequence of the 2D capacitive touch panel 220 and the 2D/3D force sensor 240 according to a scanning result obtained from scanning all the above-mentioned traces, and controls switching of the trace switch 252 according to the detected touch sequence. Next, the sensor signal S_{S}/the touch signal S_{T} is transmitted to the output port 258 via the corresponding traces. For example, when the trace switch 252 switches to the traces of the 2D capacitive touch panel 220 (i.e. the output port 258 is coupled to the input port 254 via the m+n traces including trace X₁-Xₘ and trace Y₁-Yₙ), the processor 276 may allow the touch signal S_{T} to be outputted to the output port 258 according to the scanning result obtained from scanning the traces of the 2D capacitive touch panel 220. In this embodiment, the processor 276 scans the traces line-by-line to have the touch signal S_{T} outputted to the output port 258, and then have the output signal S_{OUT} outputted to the charge detector 272. However, according a variation of this embodiment, the processor 276 may have the touch signal S_{T} outputted to the output port 258 in a pipeline manner. Therefore, more than one trace 263 is needed, and any of the number of the charge detectors 272 and the number of the ADCs 274 is required to match that of the traces 263 (i.e., it is needed to dispose a correspondent charge detector 272 and a correspondent ADC 274 for every trace 263).

Please note that the above is for illustrative purposes only, and is not meant to be a limitation to the scope of the present invention. For example, the sensing modes of the 2D capacitive touch panel 220 and the 2D/3D force sensor 240 may be a self-capacitance mode or a mutual capacitance mode, the number of traces is not limited to the above-mentioned value, and/or the 2D capacitive touch panel 220 and the 2D/3D force sensor 240 may be changed to other types of capacitive touch elements and pressure-based sensing elements respectively. In other words, any integration of input apparatuses that is realized by employing a proper trace distribution/layout and the aforementioned switching operation obeys the spirit of the present invention and falls within the scope of the present invention.

In addition, the touch event generated by the 2D/3D force sensor 240 may be a 2D touch event or a 3D touch event. When the processor 276 processes the output signal S_{OUT} to convert it into touch coordinates and other related touch data, the executed firmware may be different because the touch event may occur in the 2D capacitive touch panel 220 or the 2D/3D force sensor 240. Therefore, the shared processing unit 270 may refer to switching of the trace switch 252 for choosing to execute the firmware FW1 corresponding to a capacitive touch element (e.g., the 2D capacitive touch panel 220) or the firmware FW2 corresponding to a capacitive pressure sensor (e.g. the 2D/3D force sensor 240) to detect a touch event by processing an output signal that is generated due to the trace switch 252 switching between the capacitive touch element and the capacitive pressure sensor.

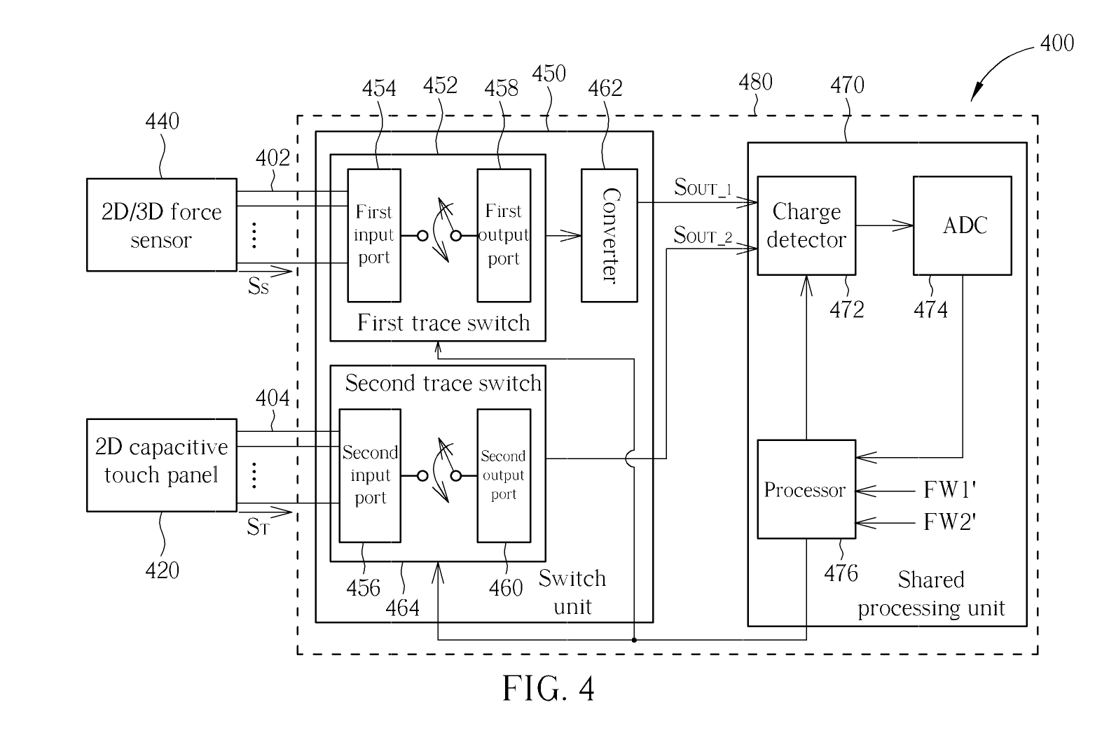

Please refer to FIG. 4, which is a diagram illustrating a second exemplary implementation of the input apparatus shown in FIG. 1. The exemplary input apparatus 400 is also based on the structure shown in FIG. 1, and thus includes, but is not limited to, a 2D capacitive touch panel 420, a 2D/3D pressure pointing stick (2D/3D pressure PST) 440, and a control circuit 480, where the control circuit 480 includes a switch unit 450 and a shared processing unit 470. In this embodiment, the switch unit 450 includes a first trace switch 452, a converter 462, and a second trace switch 464. Additionally, the shared processing unit 470 includes a charge detector 472, an ADC 474, and a processor 476. The first trace switch 452 has a first input port 454 and a first output port 458, and is used to selectively couple the first output port 458 to the first input port 454, wherein the 2D/3D pressure PST 440 is connected to the first input port 454 via traces 402. The converter 462 is coupled between the first output port 458 and the shared processing unit 470, and used to convert a voltage variation of the sensor signal S_{S} into a charge variation to generate the output signal S_{OUT}_{_{—}}₁ to the shared processing unit 470 when the first output port 458 is coupled to the first input port 454.

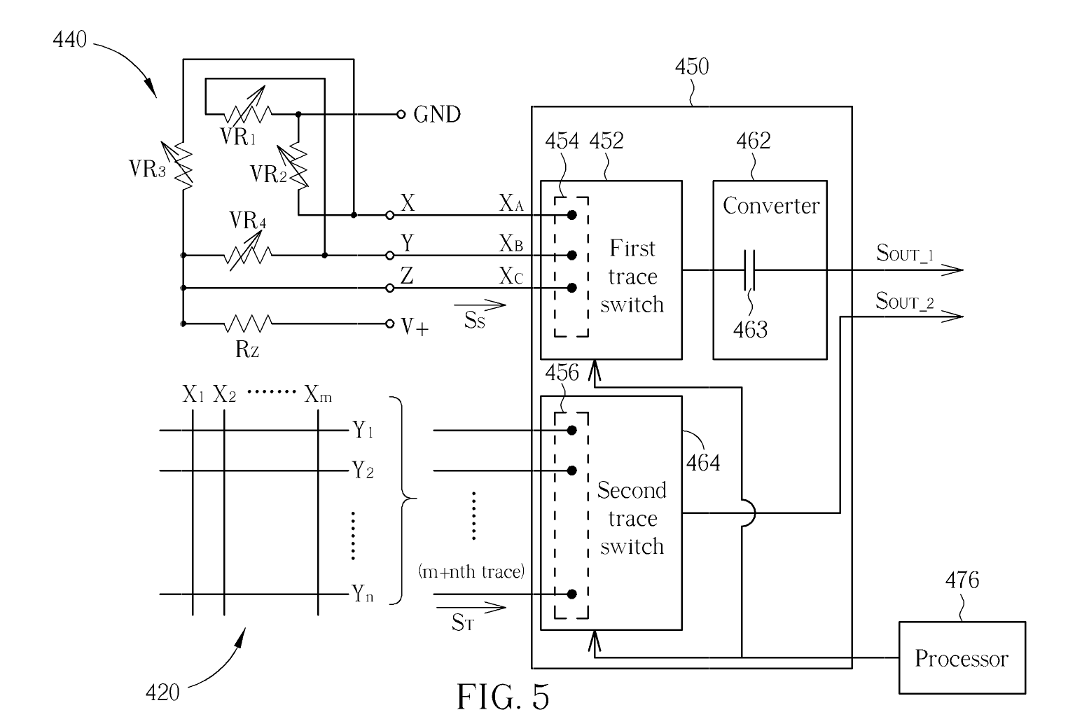

The second trace switch 464 has a second input port 456 and a second output port 460, and used to selectively couple the second output port 460 to the second input port 456, wherein the 2D capacitive touch panel 420 is connected to the second input port 456 via traces 404, and the second output port 460 outputs the touch signal S_{T} as the output signal S_{OUT}_{_{—}}₂ when the second output port 460 is coupled to the second input port 456. The charge detector 472 is coupled to the second output port 460 of the second trace switch 464 and the converter 462, and used to perform charge detection on the output signal S_{OUT}_{_{—}}₂ to generate a detection result. As the operation of ADC 474 is the same as that of the ADC 274 shown in FIG. 2, further description is omitted for brevity. Therefore, the processor 476 may also detect a touch event by executing firmware (e.g., first firmware FW1′ or second firmware FW2′). Moreover, the processor 476 controls switching of the first trace switch 452 and the second trace switch 464 according to a touch sequence of the 2D capacitive touch panel 420 and the 2D/3D pressure PST 440, and the charge detection performed by the charge detector 472 is also controlled by the processor 476. With regard to the operational details of the switch unit 450 and the trace connection, please refer to FIG. 5 in conjunction with FIG. 4.

FIG. 5 is a diagram illustrating the switching and connection of the traces shown in FIG. 4. For illustrative purposes, the 2D/3D pressure PST 440 in this embodiment is implemented using an electric bridge circuit, and the sensing mode of the 2D capacitive touch panel 420 is set to be a mutual capacitance mode. Because the 2D/3D pressure PST 440 generates a voltage variation in response to pressure, the 2D/3D pressure PST 440 and the 2D capacitive touch panel 420 are coupled to different trace switches (i.e., the first trace switch 452 and the second trace switch 464). As shown in FIG. 5, the electric bridge circuit includes a resistor R_{Z} and variable resistors VR₁, VR₂, VR₃, and VR₄, where reference voltage V₊ and ground terminal GND are used to supply the bias voltages for the electric bridge circuit. Traces X_{A}, X_{B}, and X_{C} are coupled to terminals X, Y, and Z, respectively, to transmit the sensor signal S_{S} to the first input port 454 of the first trace switch 452. In addition, the converter 462 in this embodiment is a capacitor 463 used for converting the voltage variation of the sensor signal S_{S} into a charge variation to thereby generate the output signal S_{OUT}_{_{—}}₁ to the shared processing unit 470. As the trace connection of the 2D capacitive touch panel 420 is based on the m+n traces, including trace X₁-Xₘ and trace Y₁-Yₙ shown in FIG. 3, further description is omitted for brevity.

When a touch event occurs, the processor 476 detects the touch sequence of the 2D capacitive touch panel 420 and the 2D/3D pressure PST 440 according to a scanning result obtained from scanning all the above-mentioned traces, and controls switching of the first trace switch 452 and the second trace switch 464 according to the detected touch sequence. Next, the sensor signal S_{S}/the touch signal S_{T} is transmitted to the first output port 458/the second output port 460 via the corresponding traces. For example, when the switch unit 450 switches on the first trace switch 452, the processor 476 allows the touch signal S_{S} to be outputted from the first trace switch 452 according to the scanning result obtained from scanning the traces X_{A}, X_{B}, and X_{C}, and the capacitor 463 may convert a voltage variation of the sensor signal S_{S} into a charge variation to thereby generate the output signal S_{OUT}_{_{—}}₁ to the charge detector 472. When the switch unit 450 switches on the second trace switch 464, the processor 476 allows the touch signal S_{T} to be outputted from the second trace switch 464 according to the scanning result obtained from scanning the traces of the 2D capacitive touch panel 420.

In addition, if signals are transmitted in a pipeline manner, the converter 462 may further include a plurality of capacitors, and any of the number of the charge detectors 472 and the number of the ADCs 474 is needed to match that of the capacitors. Please note that this is for illustrative purposes only, and is not meant to be a limitation to the scope of the present invention. For example, the sensing modes of the 2D capacitive touch panel 420 may be a self-capacitance mode or a mutual capacitance mode, the 2D/3D pressure PST 440 may be implemented by other types of circuits, the number of traces is not limited to the above-mentioned value, and/or the 2D capacitive touch panel 420 and the 2D/3D pressure PST 440 may be changed to other types of capacitive touch elements and pressure-based sensing elements. In other words, any input apparatus employing a proper trace distribution/layout as well as the aforementioned switching operation and electrical signal conversion obeys the spirit of the present invention and falls within the scope of the present invention.

In addition, the touch event generated by the 2D/3D pressure PST 440 may be a 2D touch event or a 3D touch event, and the sensing mode thereof may be resistive mode. When the processor 476 processes the output signal S_{OUT}_{_{—}}₁ and the output signal S_{OUT}_{_{—}}₂ to convert them into touch coordinates and other related touch data, the executed firmware may be different because the touch event may occur in the 2D capacitive touch panel 420 or the 2D/3D pressure PST 440. Therefore, the shared processing unit 470 may refer to the switching of the first trace switch 452 and the second trace switch 462 for choosing to execute the firmware FW1′ to process an output of a capacitive touch element (e.g., the 2D capacitive touch panel 420) or the firmware FW2′ to process an output of the converter 462 to detect a touch event.

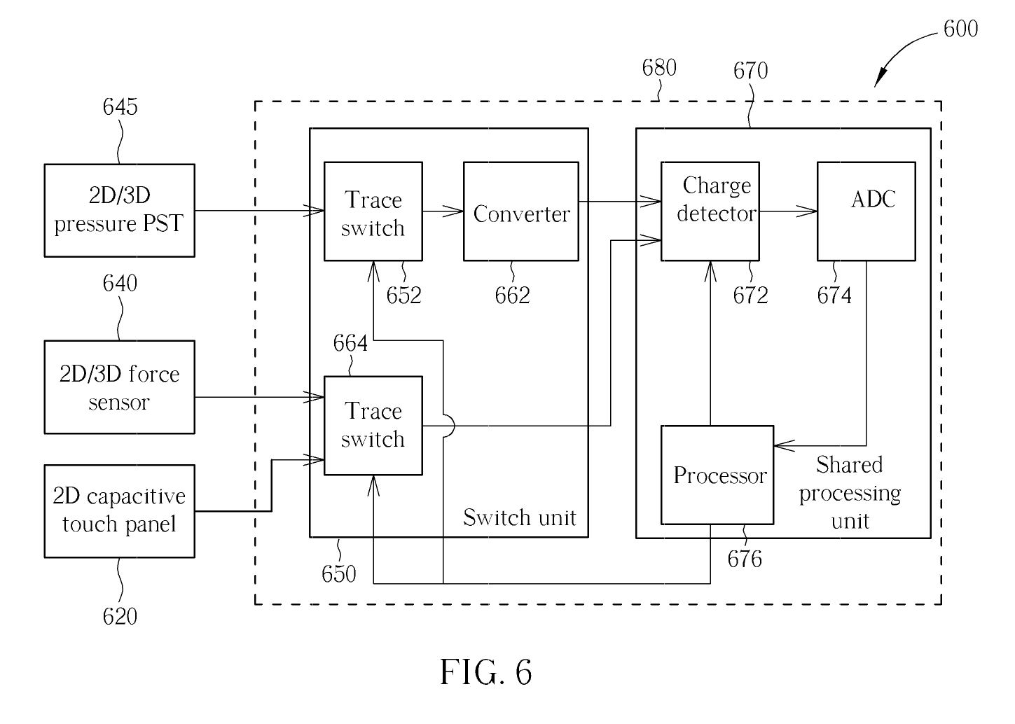

Please refer to FIG. 6, which is a diagram illustrating a third exemplary implementation of the input apparatus shown in FIG. 1. As the exemplary input apparatus 600 may be regarded as the combination of the input apparatuses 200 and 400, the exemplary input apparatus 600 therefore includes, but is not limited to, a 2D capacitive touch panel 620, a 2D/3D force sensor 640, a 2D/3D pressure PST 645, and a control circuit 680, where the control circuit 680 includes a switch unit 650 and a shared processing unit 670. The switch unit 650 includes trace switches 652 and 664, and a converter 662. Additionally, the shared processing unit 670 includes a charge detector 672, an ADC 674, and a processor 676. When a touch event occurs, the processor 676 detects a touch sequence of the 2D capacitive touch panel 620, the 2D/3D force sensor 640, and the 2D/3D pressure PST 645 according to a scanning result obtained from scanning all traces of the 2D capacitive touch panel 620, the 2D/3D force sensor 640, and the 2D/3D pressure PST 645, and controls switching of the switch unit 650 according to the detected touch sequence. Next, a sensor signal/touch signal is transmitted to the shared processing unit 670 via the corresponding traces and trace switch. As a person skilled in the art can readily understand other operational details according to above paragraphs directed to FIG. 2 to FIG. 5, further description is omitted here for brevity.

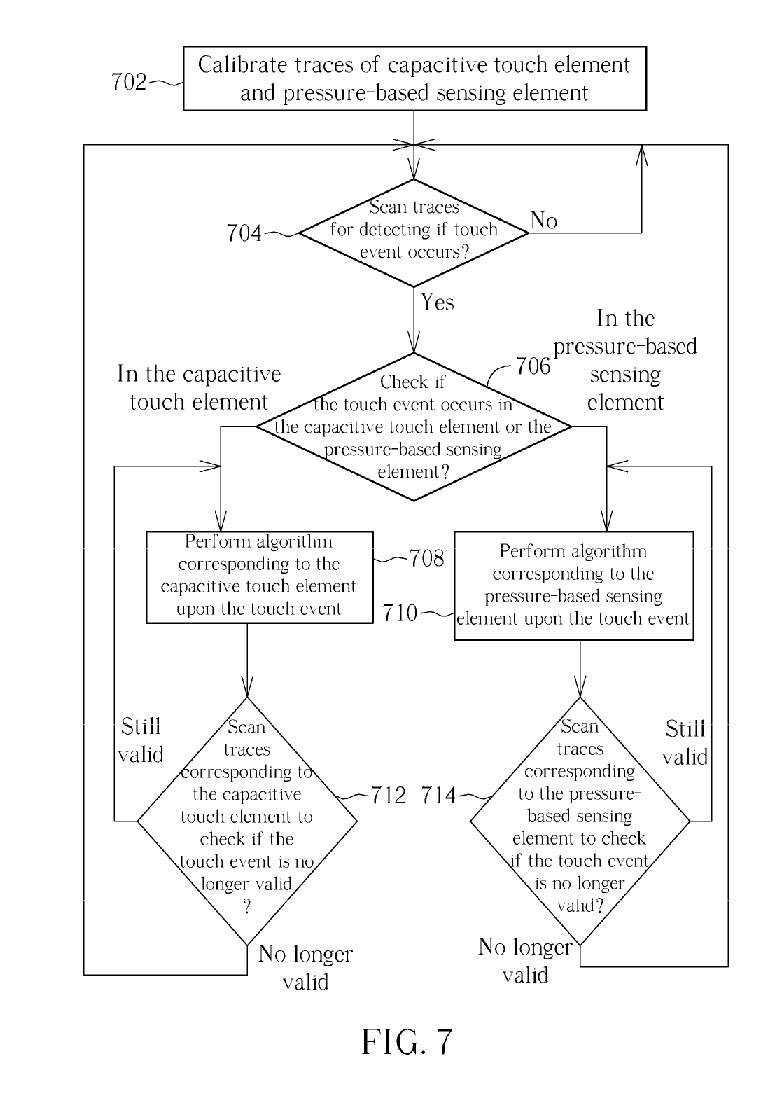

Please refer to FIG. 7, which is a flowchart illustrating the circuit switching and firmware control of the exemplary input apparatus according to the present invention. The description for each step is detailed as follows (provided that the result is substantially the same, the steps are not required to be executed in the exact order shown in FIG. 7).

Step 702: Calibrate traces of a capacitive touch element and a pressure-based sensing element;

Step 704: Scan traces for detecting if a touch event occurs. If yes, go to step 706; otherwise, go to step 704.

Step 706: Check if the touch event occurs in a capacitive touch element or a pressure-based sensing element. If the touch event occurs in the capacitive touch element, go to step 708; if the touch event occurs in the pressure-based sensing element, go to step 710.

Step 708: Perform algorithm corresponding to the capacitive touch element upon the touch event.

Step 710: Perform algorithm corresponding to the pressure-based sensing element upon the touch event.

Step 712: Scan traces corresponding to the capacitive touch element to check if the touch event is no longer valid (e.g., check if fingers have leaved the touch panel). If the touch event is still valid, go to step 708; otherwise, go to step 704.

Step 714: Scan traces corresponding to the pressure-based sensing element to check if the touch event is no longer valid (e.g., check if fingers have leaved the touch panel). If the touch event is still valid, go to step 710; otherwise, go to step 704.

Step 702 is mainly used to reduce/remove the electrical difference among the traces of the input apparatus for making the detection of the touch event more precisely. Steps 708 and 710 are separate due to the fact that the algorithm corresponding to the capacitive touch element includes processing of the 2D multi-finger touch, and the algorithm corresponding to the pressure-based sensing element includes processing of 3D sensing. In addition, in step 704, a self-capacitance or mutual capacitance sensing mode may be utilized to scan the traces corresponding to the capacitive touch element. Besides, when the pressure-based sensing element is a capacitive pressure sensor, a self-capacitance or mutual capacitance sensing mode may also be utilized to scan the traces corresponding to the capacitive pressure sensor. As a person skilled in the art can readily understand the operation of part of the steps in FIG. 7 according to conventional touch event processing methods and the operation of the remaining part of the steps in FIG. 7 according to above paragraphs directed to FIG. 2 to FIG. 6, further description is omitted here for brevity.

In summary, the present invention provides an input apparatus having circuits of the capacitive touch element and the pressure-based element integrated in a single chip, which not only provides multiple application aspects but also reduces the manufacture cost. In this way, an input apparatus with multi-function and high practical value is realized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An input apparatus, comprising:
a capacitive touch element;
at least a pressure-based sensing element; and
a control circuit, comprising:
a switch unit, coupled to the capacitive touch element and the pressure-based sensing element, for selectively generating an output signal according to a touch signal generated by the capacitive touch element or a sensor signal generated by the pressure-based sensing element; and
a shared processing unit, coupled to the switch unit, for processing the output signal to detect a touch event.

2. The input apparatus of claim 1, wherein the control circuit continues processing the touch event until the touch event is no longer valid.

3. The input apparatus of claim 1, wherein a sensing mode corresponding to the capacitive touch element is a self-capacitance mode or a mutual capacitance mode.

4. The input apparatus of claim 1, wherein the switch unit comprises:
a trace switch, having an input port and an output port, wherein each of the capacitive touch element and the pressure-based sensing element is connected to the input port via traces, the switch unit is connected to the shared processing unit via a trace, and the trace switch selectively couples the capacitive touch element or the pressure-based sensing element to the output port.

5. The input apparatus of claim 4, wherein the shared processing unit further controls switching of the trace switch according to a touch sequence of the capacitive touch element and the pressure-based sensing element.

6. The input apparatus of claim 4, wherein the shared processing unit comprises:
a processor;
a charge detector, coupled to the output port of the trace switch, for performing charge detection on the output signal outputted by the output port to generate a detection result; and
an analog-to-digital converter, coupled between the charge detector and the processor, for converting the detection result into a digital signal, and outputting the digital signal to the processor, wherein the processor detects the touch event according to the digital signal.

7. The input apparatus of claim 1, wherein the switch unit comprises:
a first trace switch, having a first input port and a first output port, for selectively couple the first output port to the first input port, wherein the press-based sensing element is connected to the first input port via traces;
a converter, coupled between the first output port and the shared processing unit, for converting a voltage variation of the sensor signal into a charge variation to generate the output signal to the shared processing unit when the first output port is coupled to the first input port; and
a second trace switch, having a second input port and a second output port, for selectively couple the second output port to the second input port, wherein the capacitive touch element is connected to the second input port via traces, and the second output port outputs the touch signal as the output signal when the second output port is coupled to the second input port.

8. The input apparatus of claim 7, wherein a sensing mode corresponding to the capacitive touch element is a self-capacitance mode or a mutual capacitance mode.

9. The input apparatus of claim 7, wherein the shared processing unit further controls switching of the first trace switch and the second trace switch according to a touch sequence of the capacitive touch element and the pressure-based sensing element.

10. The input apparatus of claim 7, wherein the shared processing unit comprises:
a processor;
a charge detector, coupled to the second output port of the second trace switch and the converter, for performing charge detection on the output signal to generate a detection result; and
an analog-to-digital converter, coupled between the charge detector and the processor, for converting the detection result into a digital signal, and outputting the digital signal to the processor, wherein the processor detects the touch event according to the digital signal.

11. The input apparatus of claim 7, wherein the converter is a capacitor.

12. The input apparatus of claim 1, wherein the pressure-based sensing element is a force sensor.

13. The input apparatus of claim 12, wherein a sensing mode corresponding to the force sensor is a self-capacitance mode or a mutual capacitance mode.

14. The input apparatus of claim 1, wherein the pressure-based sensing element is a pointing stick.

15. An input apparatus, comprising:
a capacitive touch element;
a capacitive pressure sensor;
a trace switch, coupled to the capacitive touch element and the capacitive pressure sensor, for performing switching between the capacitive touch element and the capacitive pressure sensor to generate an output signal; and
a shared processing unit, coupled to the trace switch, for referring to switching of the trace switch to selectively execute first firmware corresponding to the capacitive touch element or second firmware corresponding to the capacitive pressure sensor to process the output signal for detecting a touch event.

16. The input apparatus of claim 15, wherein the shared processing unit comprises:
a processor;
a charge detector, coupled to the trace switch, for performing charge detection on the output signal to generate a detection result; and
an analog-to-digital converter, coupled between the charge detector and the processor, for converting the detection result into a digital signal, and outputting the digital signal to the processor, wherein the processor detects the touch event according to the digital signal.

17. An input apparatus, comprising:
a capacitive touch element;
a resistive pointing stick;
a first trace switch, for selectively outputting an output of the resistive pointing stick;
a converter, for converting the output of the resistive pointing stick;
a second trace switch, for selectively outputting an output of the capacitive touch element; and
a shared processing unit, coupled to the converter and the second trace switch, for referring to switching of the first trace switch and the second trace switch to selectively execute first firmware to process the output of the capacitive touch element or second firmware to process an output of the converter for detecting a touch event.

18. The input apparatus of claim 17, wherein the shared processing unit comprises:
a processor;
a charge detector, coupled to the second trace switch and the converter, for performing charge detection on the output of the capacitive touch element or the output of the converter to generate a detection result; and
an analog-to-digital converter, coupled between the charge detector and the processor, for converting the detection result into a digital signal, and outputting the digital signal to the processor, wherein the processor detects the touch event according to the digital signal.

19. The input apparatus of claim 17, wherein the converter is a capacitor.

20. A touch event processing method, comprising:
scanning traces for detecting if a touch event occurs;
checking if the touch event occurs in a capacitive touch element or a pressure-based sensing element;
when the touch event occurs in the capacitive touch element, performing algorithm corresponding to the capacitive touch element upon the touch event; and
when the touch event occurs in the pressure-based sensing element, performing algorithm corresponding to the pressure-based sensing element upon the touch event.

21. The touch event processing method of claim 20, further comprising:
when the touch event occurs in the capacitive touch element, scanning traces corresponding to the capacitive touch element to check if the touch event is no longer valid; and
when the touch event occurs in the pressure-based sensing element, scanning traces corresponding to the pressure-based sensing element to check if the touch event is no longer valid;
wherein when the touch event is no longer valid, the traces are scanned again to detect if another touch event occurs; otherwise, a corresponding algorithm is still performed upon the touch event.

22. The touch event processing method of claim 20, wherein the step of scanning the traces for detecting if the touch event occurs comprises:
scanning traces corresponding to the capacitive touch element by utilizing a self-capacitance mode or a mutual capacitance mode.

23. The touch event processing method of claim 20, wherein the step of scanning the traces for detecting if the touch event occurs comprises:
when the pressure-based sensing element is a force sensor, scanning traces corresponding to the force sensor by utilizing a self-capacitance mode or a mutual capacitance mode.
